(19) United States
(12) Patent Application Publication
(10) Pub. No.: US 2021/0000272 A1
(43) Pub. Date: Jan. 7, 2021

(54) ARTICLE FOR A DRINKING VESSEL

(71) Applicant: Danny Muallem, Cameron Park, CA (US)

(72) Inventor: Danny Muallem, Cameron Park, CA (US)

(21) Appl. No.: 17/028,208

(22) Filed: Sep. 22, 2020

(51) Int. Cl. A47G 19/22; F21S 10/06

(52) U.S. Cl. CPC A47G 19/2255; A47G 19/2227; F21Y 2113/10; A47G 2019/2238; F21S 10/06

(57) ABSTRACT

The present invention is directed to a drinking vessel comprising a glassware having a liquid holding part and a stem extending downwards and away from the liquid holding part, an outer surface of the stem having threads; an elongated article having an inner aperture, the inner aperture having threads that corresponds to the threads of the stem, wherein the elongated article is configured to be fit around the stem of the glassware, such that the threads of the inner aperture engage with the threads of the stem for securing the elongated article over the stem.

### FIELD OF INVENTION

The present disclosure is directed to an article for a drinking vessel, and particularly, the present disclosure is directed to an article that can fit around a drinking vessel.

### BACKGROUND

Glassware such as stemware is one of the popular drinking vessels. These are generally available in a set having multiple glasswares. However, glasswares generally have limited design options. Moreover, it is difficult to differentiate between similar looking glasswares containing similar beverages. Persons drinking the same beverage from similar looking-glasswares can often mix-up the glassware and it is difficult to identify if which glassware belongs to whom. Also, it is a general tendency of human beings to customize articles.

Thus, a need is appreciated for an article that can be used to customize drinking vessels, and particularly, a need is appreciated for an article that can be used to customize stemware.

### SUMMARY OF THE INVENTION

The principal object of the present disclosure is therefore directed to glassware and an article for customizing the glassware.

It is a further object of the present disclosure that the article can increase the height of the glassware.

It is an additional object of the present disclosure that the article can differentiate between the identical looking glasswares.

It is still an additional object of the present disclosure that the article could be produced in distinct colors and shapes.

It is yet an additional object of the present disclosure that the article provides a blank space for writing.

It is yet another object of the present disclosure that the article is economical to manufacture.

In one aspect, the present disclosure is directed to glassware and an article that can fit around the stem of the glassware. The glassware having a liquid holding portion and a stem extending downwards and away from the liquid holding portion. The outer surface of the stem of the glassware can be configured with threads. The article can be configured to fit around the stem of the glassware. The article is of an elongated configuration having an inner aperture. The inner aperture having threads such as the article can fit over the stem by screwing the article over the stem, wherein the threads of the stem and the threads of the inner aperture of the stem can engage. The article can be manufactured in different shapes, designs, and colors. The article can also be provided with a blank space that can be marked with ink.

In one aspect, the article disclosed herein can be of a height lesser, same, or larger than the stem of the glassware, such that the height of the glassware can be varied. In one implementation, the article can be engaged up to a certain length of the stem, thus increasing the height of the glassware. In one implementation, the article can have a height larger than the length of the stem.

In one aspect, the article can be provided with a light source and batteries for illuminating the glassware.

In one aspect, the article can be provided with a magnetic coupling that can magnetically engage to a supporting surface, such as a tabletop.

In one aspect, the stem of the glassware can include an aperture that opens towards the bottom of the stem. A plug shaped to fit into the aperture of the stem is also disclosed herein. The plug can be inserted from the bottom of the stem into the aperture. Once, the plug is fully inserted into the aperture of the stem, the bottom of the plug and the bottom of the stem can be coplanar. In one implementation, the plug can be provided in different shapes and colors. In one implementation, the plug can be provided with a light source and a battery to illuminate the glassware. In one implementation, the plug can be provided with magnetic coupling for magnetically engaging the glassware containing the plug to a supporting surface.

These and other objects and advantages of the embodiments herein will become readily apparent from the following detailed description.

### BRIEF DESCRIPTION OF THE DRAWINGS

FIG. 1 shows an implementation of glassware having a stem, the stem having threads on its outer surface.

FIG. 2 shows an implementation of an article fit around the stem of the glassware.

FIG. 3 shows a cross-section view of a glassware having an aperture that opens at a bottom of the stem of the glassware.

FIG. 4 shows an implementation of a plug of a shape commensurate with the shape of the aperture shown in FIG. 3, such as the plug can fit into the aperture.

FIG. 5A shows the plug of FIG. 4 having a magnet.

FIG. 5B shows the plug of FIG. 4 having a pair of light sources.

FIG. 6 shows another implementation of the article.

FIG. 7 shows the article of FIG. 6 fit around the stem of the glassware.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as an article of manufacture or an apparatus. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and devices are shown in block diagram form in order to facilitate describing the subject innovation. Moreover, the drawings may not be to scale.

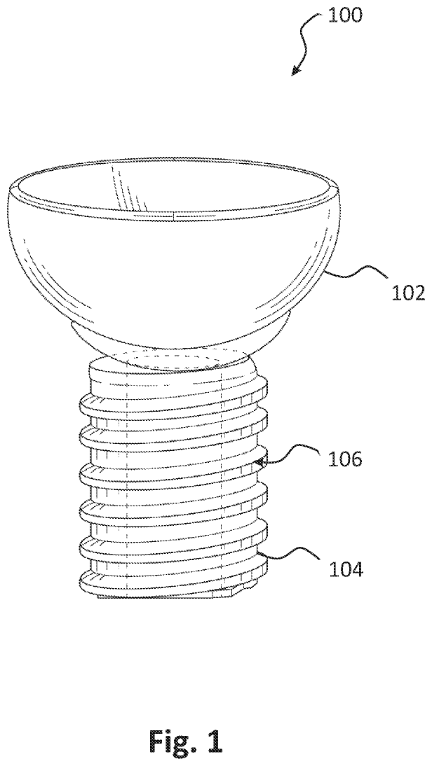

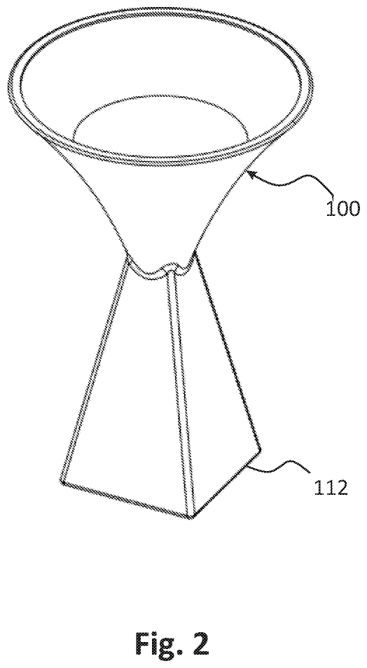

Now referring to FIG. 1, which is a drinking vessel, the drinking vessel includes a glassware 100 having a liquid holding portion 102 and a stem 104 that extends downwards and away from the liquid holding portion 102. The outer surface of the stem having threads 106. The glassware 100 including the stem can be manufactured from glass. FIG. 2 shows the glassware 100 having an article 112 around its stem. The article 112 is of an elongated configuration having an inner elongated aperture. The inner elongated aperture having threads that allow the article 112 to fit around the stem 104 of the glassware. The inner elongated aperture of the article 112 is such that it can be screwed to the stem 104 of the glassware 100, such that the threads of the stem and the threads of the article 112 can engage to secure the article 112 over the stem 104 of the glassware 100. Article 112 shown in FIG. 2 is having a flat bottom that faces a supporting surface over which the glassware 100 can be kept. In an alternate implementation, the article can be hollow, wherein the inner aperture extends within the length of the article.

In one implementation, the article can be manufactured in diverse colors and designs. This allows both customization and personalization of the glassware. A set of same looking glassware can be personalized by putting the article of distinct color. Moreover, the article can include a blank space over which a user can write using ink. The ink can be temporary or permanent. The height of the article can be smaller, equal, or larger than the height of the stem of the glassware. In case, the height of the article is larger than the stem, the article results in increasing the height of the glassware. Overall height of the drinking vessel increases. The height of the glassware can also be increased by partially screwing the article over the stem. This may allow to vary the height of the drinking vessel, thus resulting in variable height drinking vessel. In case, the height of the article is smaller than the height of the stem, the article is preferably hollow. A portion of the stem can protrude from the bottom of the hollow article.

In one implementation, besides the distinct color and design, the article can also be configured with a light source for illumination either the article or the glassware or both. The light source can be an energy-efficient LED powered by a battery which is also enclosed in the article. In one case, more than one LED can be configured in the article, wherein more than one LED is of distinct colors. In one case, the LED can be coupled to an energy-efficient oscillator that causes the LED to blink.

In one case, the article can also be configured with a magnet. Preferably, the bottom of the article can be configured with the magnet. The magnet can allow the article to magnetically engage with a supporting surface, such as a tabletop over which the drinking vessel is kept. Also, the table cover can have a magnetic material or metallic material that can magnetically couple with the magnet of the article.

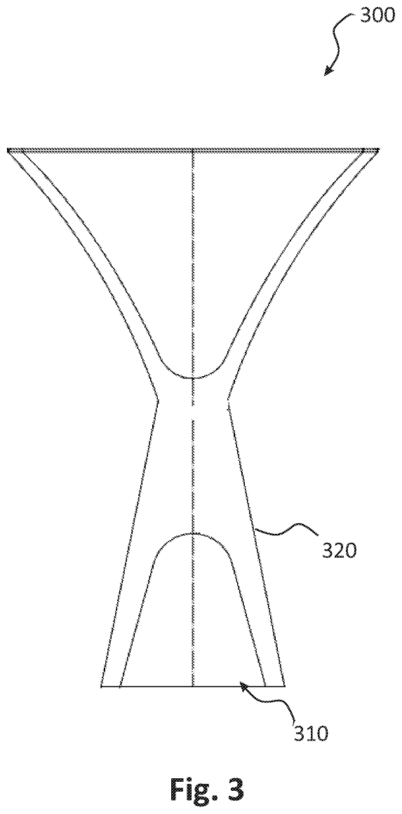

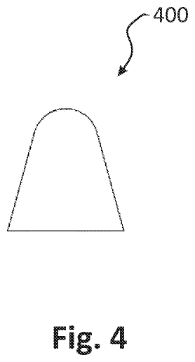

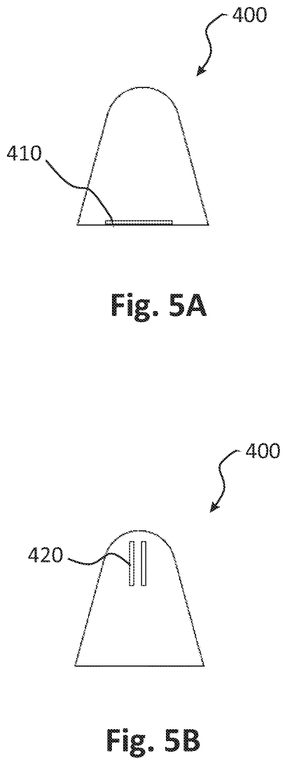

FIG. 3 shows a vertical cross-section view of the glassware 300 having an aperture 310 in the lower portion of the stem 320 of the glassware, wherein the aperture opens at the bottom of the stem of the glassware. FIG. 4 shows a plug 400 that is of a shape commensurate to the shape of the aperture 310. The plug 400 can be made of rubber or silicone and can fit into the aperture 310. The plug 400 can be manufactured in distinct colors which may help to customize and personalize the glassware. The plugs can be interchangeably fit into the stem of the glassware. Moreover, shown in FIGS. 5A and 5B, the plugs can be provided with a light source 420 and a magnet 410. The light source and magnets can operate as the light source and magnets for the article disclosed herein.

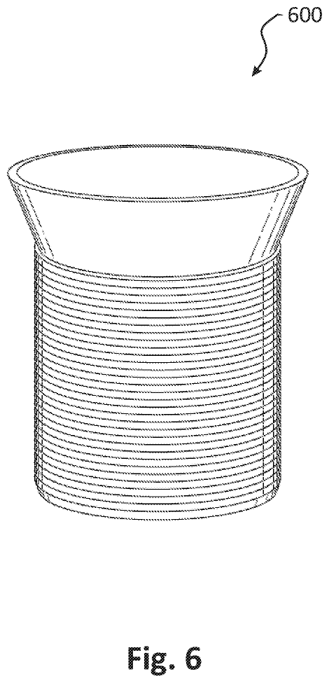

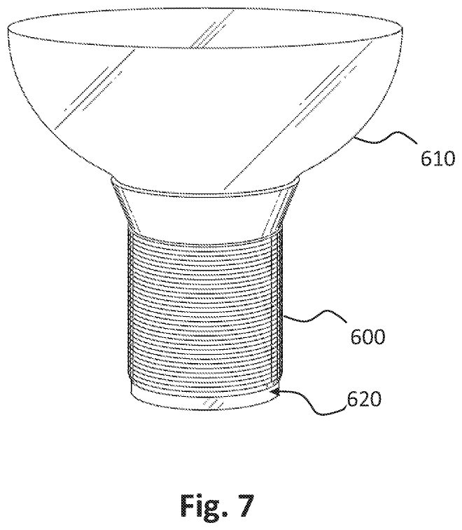

Now referring to FIG. 6 which shows an implementation of article 600, wherein the article 600 is of a length shorter than the length of the stem of the glassware. FIG. 7 shows the article 600 screwed to a stem of a glassware 610. A portion of the stem 620 is visible at bottom of the glassware 610. Herein the bottom is of sufficient area to stabilize the glassware over a supporting surface, such as a tabletop. The article 600 can be manufactured in distinct colors and designs to customize and personalize the glassware.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A drinking vessel comprising:
a glassware having a liquid holding part and a stem extending downwards and away from the liquid holding part, an outer surface of the stem having threads;
an elongated article having an inner aperture, the inner aperture having threads that correspond to the threads of the stem, wherein the elongated article is configured to fit around the stem of the glassware, such that the threads of the inner aperture engage with the threads of the stem for securing the elongated article over the stem.

2. The drinking vessel of claim 1, wherein the elongated article is screwed over the stem.

3. The drinking vessel of claim 1, wherein the elongated article is having a flat bottom configured to support the drinking vessel over a supporting surface.

4. The drinking vessel of claim 1, wherein the elongated article is hollow, wherein the inner aperture extends within the length of the elongated article.

5. The drinking vessel of claim 4, wherein the length of the elongated article is lesser than the length of the stem of the glassware.

6. The drinking vessel of claim 5, wherein the stem of the glassware is having a flat bottom that is of a size to support the drinking vessel over a supporting surface.

7. The drinking vessel of claim 6, wherein the supporting surface is a tabletop.

8. The drinking vessel of claim 3, wherein the length of the elongated article is more than the length of the stem of the glassware.

9. The drinking vessel of claim 1, wherein the elongated article further comprises at least one light source.

10. The drinking vessel of claim 9, wherein the light source is configured to produce illumination of at least two colors.

11. The drinking vessel of claim 9, wherein the light source is configured with an oscillator for producing a blinking effect.

12. The drinking vessel of claim 3, wherein the flat bottom of the elongated article further comprises at least one magnet.

13. A drinking vessel comprising:
a glassware having a liquid holding part and a stem extending downwards and away from the liquid holding part, the stem having an aperture that opens at a bottom of the stem; and
a plug configured to fit into the aperture of the stem, the plug having a color distinct from a color of the glassware,
wherein bottom of the plug and the bottom of the stem are coplanar when the plug is inserted into the aperture of the stem.

14. The drinking vessel of claim 13, wherein the plug comprises at least one light source.

15. The drinking vessel of claim 14, wherein the light source is configured to produce illumination of at least two colors.

16. The drinking vessel of claim 14, wherein the light source is configured with an oscillator for producing a blinking effect.

17. The drinking vessel of claim 13, wherein the plug comprises at least one magnet.

18. The drinking vessel of claim 13, wherein the plug is made of silicone or rubber.

19. The drinking vessel of claim 13, wherein an outer surface of the stem further comprises threads and the drinking vessel further comprises:
an elongated article having an inner aperture, the inner aperture having threads that correspond to the threads of the stem, wherein the elongated article is configured to fit around the stem of the glassware, such that the threads of the inner aperture engage with the threads of the stem for securing the elongated article over the stem.

20. The drinking vessel of claim 19, wherein length of the elongated article is lesser than length of the stem such that a portion of the stem having the plug protrudes from a bottom of the elongated article.
